(19) United States
(12) Patent Application Publication
(10) Pub. No.: US 2026/0104829 A1
(43) Pub. Date: Apr. 16, 2026

(54) IMAGE PROCESSING APPARATUS, AND CONTROL METHOD

(71) Applicant: BROTHER KOGYO KABUSHIKI KAISHA, Nagoya (JP)

(72) Inventor: Shintaro KUNIMOTO, Inazawa (JP)

(21) Appl. No.: 19/340,254

(22) Filed: Sep. 25, 2025

(30) Foreign Application Priority Data
Oct. 11, 2024 (JP) 2024-178835

(51) Int. Cl. G06F 3/12; H04N 1/00

(52) U.S. Cl. CPC G06F 3/1217; G06F 3/1224; H04N 1/00411; H04N 2201/0094

(57) ABSTRACT

An image processing apparatus includes: a user interface; and a communication interface. The image processing apparatus is operable in a first mode and a second mode in which the image processing apparatus stores command information based on received control command. Depending on acceptance of a first operation, the image processing apparatus is configured to change to the second mode. In a case where the image processing apparatus receives the control command in the second mode, the image processing apparatus is configured to change to a state of waiting for a second operation. In a case where the image processing apparatus receives the control command in the first mode, the image processing apparatus is configured not to change to the state of waiting for the second operation. The image processing apparatus is configured to execute a specified process based on the command information, depending on acceptance of the second operation.

### REFERENCE TO RELATED APPLICATIONS

This application claims priority from Japanese Patent Application No. 2024-178835 filed on October 11, 2024. The entire content of the priority application is incorporated herein by reference.

### BACKGROUND ART

In a known technique, an image processing apparatus as a control target is selected via a management apparatus and is controlled, in a state that the plurality of image processing apparatuses is connected to an information processing apparatus serving as the management apparatus. For example, in a known configuration, a printer marked through operation of a button on an operation panel is displayed as the marked printer on a screen provided by a utility which is an application program of the information processing apparatus.

### SUMMARY

In a case where the plurality of image processing apparatuses is connected to the information processing apparatus, it is not clear, in some cases, as to which one of the image processing apparatuses listed on the screen of the information processing apparatus is the control target. According to the above-described technique, identification of the control target is expected to be easy since the control target is displayed while being marked. However, in such a case where two different image processing apparatuses connected to the same network are managed, respectively, by two persons, e.g. an administrator A and an administrator B via two information processing apparatuses each of which is operated by one of the administrators A and B, the image processing apparatus operated to be marked by the administrator A as the management target is displayed as the marked image processing apparatus also in the information processing apparatus of the administrator B. Accordingly, the administrator B might instruct to transmit a control command to the image processing apparatus of the management target of the administrator A, in some cases.

An aspect of the present disclosure is an image processing apparatus including a user interface; anda communication interface. The image processing apparatus is operable in at least two modes including:a first mode in which, in a case where the image processing apparatus receives a control command transmitted by a program of an information processing apparatus via the communication interface, the image processing apparatus reads and discards the received control command; anda second mode in which, in a case where the image processing apparatus receives the control command via the communication interface, the image processing apparatus stores, in a memory, command information based on the received control command. Depending on acceptance of a first operation via the user interface by the image processing apparatus operating in the first mode, the image processing apparatus is configured to change from the first mode to the second mode. In a case where the image processing apparatus receives the control command via the communication interface while operating in the second mode, the image processing apparatus is configured to change to a state of waiting for a second operation satisfying an execution condition of a specified process corresponding to the received control command. In a case where the image processing apparatus receives the control command via the communication interface while operating in the first mode, the image processing apparatus is configured not to change to the state of waiting for the second operation. The image processing apparatus is configured to execute the specified process corresponding to the control command, based on the command information stored in the memory, depending on acceptance of the second operation via the user interface in the state of waiting for the second operation.

The image processing apparatus described in the present specification changes to the state of waiting for the second operation in a case where the image processing apparatus receives the control command while operating in the second mode, and execute the specified process corresponding to the control command in a case where the image processing apparatus accepts the second operation by a user. Further, in a case where the user transmits the control command from the program of the information processing apparatus, the user causes the image processing apparatus, as the control target, to change from the first mode to the second mode by performing the first operation with respect to the image processing apparatus. In other words, even in a case where the user does not specify the image processing apparatus as the control target in the information processing apparatus, the specified process corresponding to the control command is executed in the image processing apparatus regarding which the first and second operations have been performed by the user. On the other hand, in another image processing apparatus regarding which the first operation has not been performed, the another image processing apparatus is not operating in the second mode. Accordingly, even in a case where the control command is transmitted to the another image processing apparatus, the another image processing apparatus reads and discards the control command, and does not change to the state of waiting for the second operation. Therefore, the specified process will not be executed by the another image processing apparatus which is not the control target.

An aspect of the present disclosure is an image processing apparatus including: a user interface; and a communication interface. The image processing apparatus is configured to wait for reception of a control command transmitted by a program of an information processing apparatus, depending on acceptance of a first operation via the user interface. Depending on the reception of the control command via the communication interface by the image processing apparatus waiting for the reception of the control command, the image processing apparatus is configured to store, in a memory, command information based on the received control command, and to change to a state of waiting for a second operation satisfying an execution condition of a specified process corresponding to the received control command. Depending on acceptance of the second operation via the user interface by the image processing apparatus in the state of waiting for the second operation, the image processing apparatus is configured to execute the specified process corresponding to the control command based on the command information stored in the memory.

An aspect of the present disclosure is a control method for an information processing apparatus. The control method includes: causing the information processing apparatus to execute an instruction acceptance process of accepting transmission instructions of a control command via a user interface of the information processing apparatus; and causing the information processing apparatus to execute, depending on acceptance of the transmission instructions: a determination process of determining an execution condition of a specified process corresponding to the control command; and a transmission process of transmitting, to a plurality of image processing apparatuses via a communication interface of the information processing apparatus, the control command in association with condition information indicating the execution condition determined in the determination process. Each of the plurality of image processing apparatuses to which the control command is to be transmitted in the transmission process is an image processing apparatus which is: operable in at least two modes including: a first mode in which, in a case where the image processing apparatus receives the control command, the image processing apparatus reads and discards the received control command; and a second mode in which, in a case where the image processing apparatus receives the control command, the image processing apparatus stores, in a memory, command information based on the received control command; configured to change from the first mode to the second mode depending on acceptance of a first operation; configured to change to a state of waiting for a second operation satisfying the execution condition, in a case where the image processing apparatus receives the control command while operating in the second mode; configured not to change to the state of waiting for the second operation, in a case where the image processing apparatus receives the control command while operating in the first mode; and configured to execute the specified process corresponding to the control command based on the command information stored in the memory depending on acceptance of the second operation in the state of waiting for the second operation.

The control method described in the present specification causes the information processing apparatus to execute the process of determining the execution condition of the specified process and of transmitting the control command to the plurality of image processing apparatuses, in accordance with instructions of a user. In a case where the image processing apparatus, of the plurality of image processing apparatuses, is operating in the first mode, the image processing apparatus reads and discards the transmitted control command, whereas in a case where the image processing apparatus is operating in the second mode, the image processing apparatus stores the command information in the memory. Accordingly, even in a case where the user does not specify, in the information processing apparatus, the image processing apparatus as the control target, the specified process is not performed by an image processing apparatus, of the plurality of image processing apparatuses, which is not the control target.

A program to be incorporated into the above-described image processing apparatus, a computer-readable storage medium storing the program, a control method for realizing the function of the program, and a system including the image processing apparatuses and the information processing apparatus are also novel and useful.

The technique described in the present specification contributes to realizing, in a system in which a plurality of image processing apparatuses are connected to a network, the technique capable of appropriately controlling an image processing apparatus as a control target among the plurality of image processing apparatuses, from an information processing apparatus connected to the network.

### BRIEF DESCRIPTION OF DRAWINGS

FIG. 1 is a block diagram illustrating a schematic configuration of a system.

FIGS. 2A and 2B are a sequence chart indicating an example of an application procedure.

FIG. 3 is a view illustrating an example of a list display screen.

FIG. 4 is a view illustrating an example of a status notification screen.

FIG. 5 is a view illustrating an example of a standby screen.

FIG. 6 is a view illustrating an example of a status notification screen.

FIGS. 7A and 7B are a flowchart indicating an example of a procedure of an application process in a printer.

FIGS. 8A to 8F are views illustrating an example of a change in the state of the printer in a case where the printer receives a plurality of control commands.

### DESCRIPTION

In the following, a system of an embodiment will be described in detail, with reference to the attached drawings. The present specification describes a system which includes a personal computer (hereinafter referred to as "PC") and a plurality of printers.

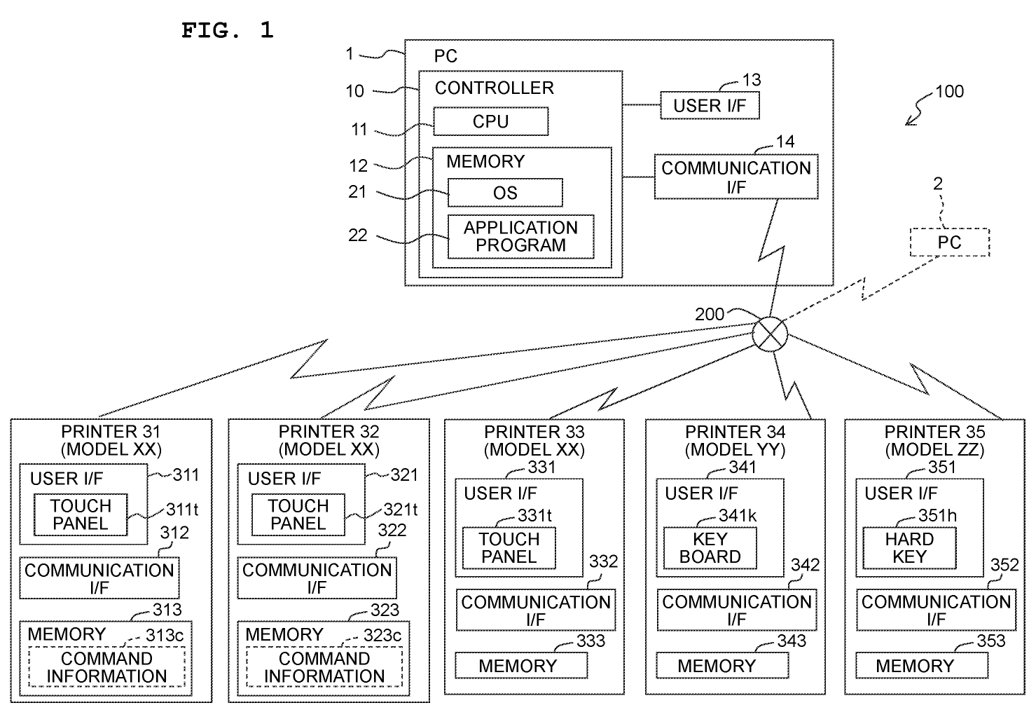

A system 100 of the present embodiment has a configuration in which a PC 1 and a plurality of printers are connected via a network 200, as depicted in FIG. 1. The PC 1 is an example of an "information processing apparatus", and the plurality of printers are each an example of an "image processing apparatus".

The system 100 of the present embodiment as depicted in FIG. 1 includes: printers 31, 32, and 33 which are of the same model, namely, a "model XX"; a printer 34 which is of a "model YY"; and a printer 35 which is of a "model ZZ". Each of the printers 31, 32, 33, 34, and 35 may be a printer dedicated to cut sheets, a printer capable of printing on a continuous sheet, or a label printer dedicated to label sheets. Although only the five printers are depicted in FIG. 1, the system 100 may further include a number of printers, such as several tens of printers. Further, the image processing apparatus included in the system 100 is not limited to the printers, and may also be, for example, a scanner, a copying machine, a multi-function peripheral, and a facsimile machine.

Each of the printers included in the system 100 has a user interface (hereinafter referred to as "user I/F"), a communication interface (hereinafter referred to as "communication I/F"), and a memory. The communication I/F of each of the printers includes hardware capable of wireless communication with the network 200 via, for example, Ethernet, or Wi-Fi (a registered trademark of Wi-Fi Alliance).

The user I/F of each of the printers includes at least hardware which is capable of accepting a user operation. The user IF of each of the printers may include hardware which displays a screen to notify the user of information. The user I/F of each of the printers includes, for example, at least one of: a hardware key (hereinafter referred to as a "hard key"), such as a start key or a cancel key, a keyboard capable of accepting input of a letter and a number, or a liquid crystal display with a touch panel (hereinafter referred to as a "touch panel").

In an example depicted in FIG. 1, the printer 31 has a user I/F 311 including a touch panel 311t, a communication I/F 312, and a memory 313. The printer 32 has a user I/F 321 including a touch panel 321t, a communication I/F 322, and a memory 323. The printer 33 has a user I/F 331 including a touch panel 331t, a communication I/F 332, and a memory 333. The printer 34 has a user I/F 341 including a keyboard 341k, a communication I/F 342, and a memory 343. The printer 35 has a user I/F 351 including a hard key 351h, a communication I/F 352, and a memory 353.

The PC 1 included in the system 100 has a controller 10 including a CPU 11 and a memory 12, as depicted in FIG. 1. The PC 1 also has a user I/F 13 and a communication I/F 14 which are electrically connected to the controller 10. Note that the controller 10 in FIG. 1 is a generic term for hardware and software used to control the PC 1, and does not necessarily represent a single hardware actually present in the PC 1.

The CPU 11 executes various processes in accordance with a program read from the memory 12, or based on user operation. The memory 12 stores various programs including an operating system (hereinafter referred to as "OS") 21 and an application program 22, and various data. The application program 22 is an example of a "program". The memory 12 is also used as a work area in a case where the various processes are executed. Note that the CPU 11 may read the application program 22 from a storage mediumwhich is readable by the CPU 11. The PC 1 is capable of using, for example, a CD-ROM, a DVD-ROM, and a USB memory, as a storage medium which is readable by the CPU 11.

The user I/F 13 includes hardware which displays a screen for notifying the user of information, and hardware which accepts the user operation. The communication I/F 14 includes hardware for wireless communication with each of the printers via the network 200. The PC 1 may include a plurality of communication I/Fs 14 each corresponding to one of a plurality of communication standards.

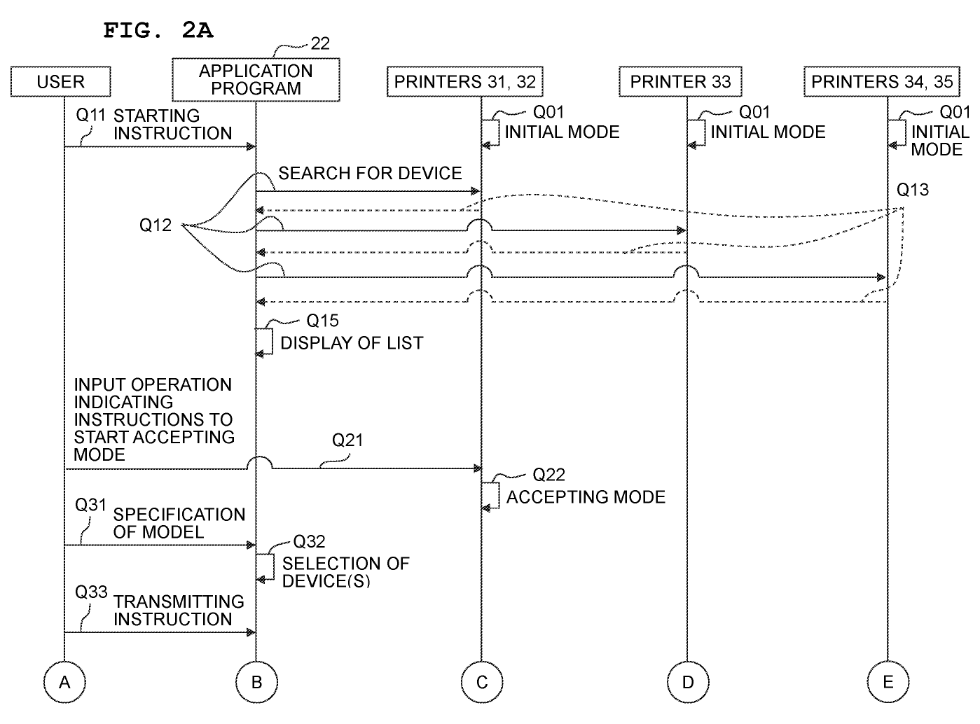

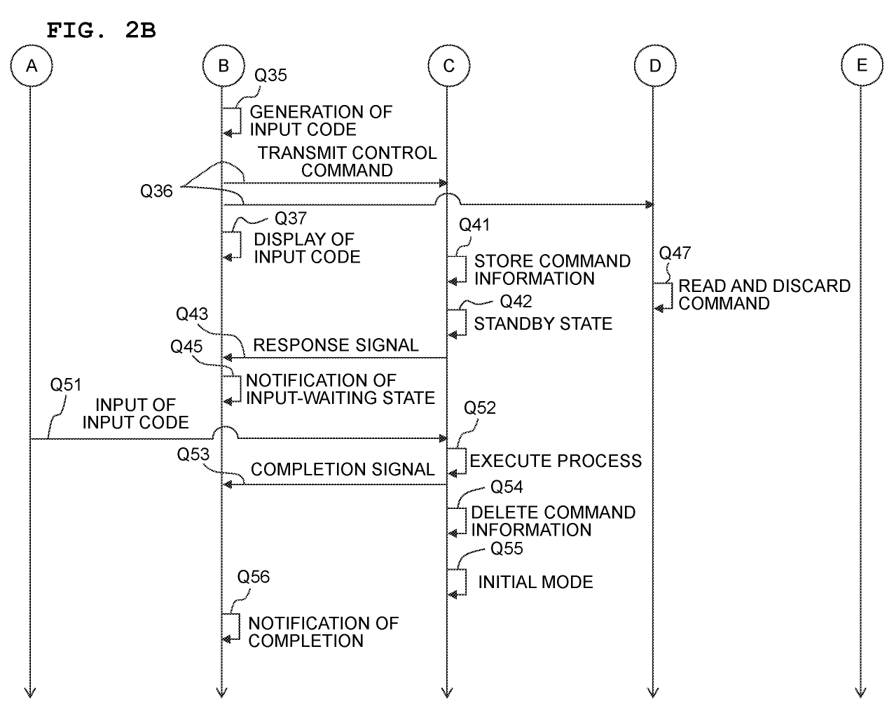

Next, application procedure for controlling the plurality of printers using the application program 22 will be described, with reference to a sequence chart of FIGS. 2A and 2B. FIGS. 2A and 2B illustrate application procedure for a user who manages the PC 1 to apply the same setting to the printers 31 and 32, which are of the same model, by using the application program 22.

Each of the plurality of printers is powered up and started, and changes to an initial mode, before the application procedure is started (Q01). The initial mode is an example of a "first mode". The printer of the initial mode is capable of accepting the user operation and is capable of performing an operation based on the user operation. Further, before the application procedure is started, each of the printers is connected to the network 200. In other words, before the application procedure is started, each of the printers has changed to be capable of accepting the user operation and executing the operation based on the user operation, as well as communicating, for example, with the PC 1 via the network 200.

The user who performs the application procedure starts the application program 22 on the PC 1 and inputs a starting instruction for starting controlling of the printers (Q11). The application program 22 searches for a device connected to the PC 1 in accordance with the starting instruction (Q12). Specifically, the application program 22 broadcasts a search signal via the communication I/F 14 of the PC 1, and attempts to obtain, from a device which has transmitted a response signal, information on the device (Q13). With this, the application program 22 can extract one or more devices selectable as control target(s). In the system 100 depicted in FIG. 1, the application program 22 selects five printers 31 to 35, as controllable printers.

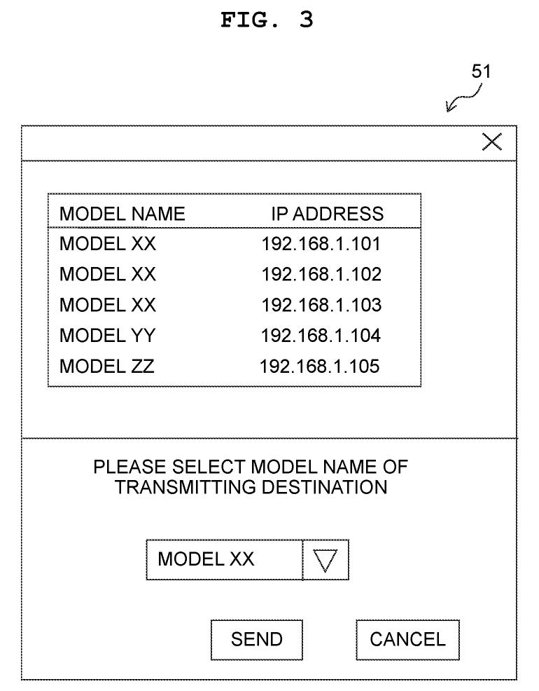

The application program 22 causes the user I/F 13 of the PC 1 to display a list display screen 51 showing a list of the extracted printers, for example, as depicted in FIG. 3 (Q15). For example, regarding each of the printers which can be controlled by the application program 22, model name and IP address are displayed in association with each other in the list display screen 51. The IP address is identification information which identifies each of the printers. Note that the identification information is not limited to the IP address, and may also be a MAC address, serial number, etc.

The user performs an input operation indicating instructions to start an accepting mode with respect to each of the printer 31 and the printer 32 as the control target to which the setting is applied using the application procedure, via the user I/F 311 and the user interface 321, respectively (Q21). Each of the printers is capable of operating in at least two modes, which are the initial mode and the accepting mode. The input operation indicating the instructions to start the accepting mode is an example of a "first operation".

Each of the printers may be capable of accepting the instructions to start the accepting mode by, for example, a long or continuous press of a predetermined key, a simultaneous press of a plurality of keys, or operation of a plurality of keys in a predetermined order. Further, in a case where each of the printers has a dedicated key for accepting the input of the instructions to start the accepting mode, the user may operate the dedicated key. Furthermore, a printer which has a touch panel may also be capable of accepting the input of the instructions to start the accepting mode via operation of a predetermined button displayed on the touch panel.

Each of the printer 31 and the printer 32 changes to the accepting mode in accordance with the input operation in the process of Q21 (Q22). The accepting mode is an example of a "second mode". Each of the printers is capable of receiving a control command transmitted from an external apparatus. In a case where a printer receives the control command while in the accepting mode, the printer stores command information based on the received control command in the memory, and changes to a standby state. The details of the accepting mode and the standby state will be described later. The printers 31 and 32 may notify that the printers 31 and 32 have changed to the accepting mode via, respectively, the user I/Fs 311 and 321. Note that the printer 33, the printer 34 and the printer 35 remain in the initial mode since these printers 33, 34 and 35 have not accepted the input operation of Q21.

The user specifies the model as the control target in the application program 22 (Q31). The application program 22 is capable of accepting the selection of the printer(s) as the control target(s) via, for example, indicating of the model name in the list display screen 51 which is displayed. In accordance with the instruction in the process of Q31, the application program 22 selects all printers which are of the specified model as the control target (Q32). In a case where the user has selected the "model XX" in the process of Q31, the application program 22 selects the printer 31, the printer 32, and the printer 33 as the control targets.

Note that the function to select the printers through the model specification may be omitted in the application program 22. In a case where application program 22 does not have the function to select the printers through the model specification, the user does not perform the process of Q31, and the application program 22 does not perform the process of Q32. In this case, the application program 22 may make all the printers displayed in the process of Q15 the target of setting, or the application program 22 may accept regarding each of the printers, the selection of whether to make the printer the target of setting.

The user specifies information on a specified process to be transmitted to each of the printers which have been selected as the control target, and enters transmission instructions in the application program 22 (Q33). The information on the specified process is information including one or more commands to be executed by each of the printers. The information on the specified process is, for example, information including a setting command that includes information on an item or a parameter regarding which each of the printers is caused to change main device setting, or a firmware updating command for causing the each of the printers to update the firmware.

Upon receiving the instruction of Q33, the application program 22 generates an input code (Q35). The input code is information having the following meaning. That is, in a case where a printer accepts an input operation of the input code, the printer satisfies an execution condition of a process based on a setting information. The input code is an example of "condition information", and is an example of a "passcode". The process of Q35 is a process of causing the PC 1 to determine the input code, and is an example of a "determination process".

The input code is information indicating an operation which is acceptable by the model as the control target. The input code may be information indicating a string of letters or numbers which can be entered via a keyboard or numeric keypad, and may also be information indicating a predetermined operation with respect to the hard key included in the printer, such as an operation of simply pressing a predetermined key, a long or continuous press of a predetermined key, a simultaneous press of a plurality of keys, or operation of a plurality of keys in a predetermined order. Specifically, the predetermined operation may be exemplified by: an operation of pressing the start key, an operation of pressing the start key while pressing the cancel key, etc. Note that the input operation of the input code may be an operation different from the above-described input operation indicating the instructions to start the accepting mode.

The application program 22 generates a control command being a combination of the information on the generated input code and the information on the specified process instructed in the process of Q33, and transmits the generated control command to all the printers selected in the process of Q32 via the communication I/F 14 of the PC 1 (Q36). The process of Q36 is an example of a "transmission process". In a configuration of FIG. 1, in a case where the "model XX" is selected as depicted in FIG. 3, the application program 22 transmits the control command to the printer 31, the printer 32, and the printer 33, but does not transmit the control command to the printer 34 and the printer 35 which are of the different models.

In other words, depending on acceptance of the transmission instructions in the process of Q33, the application program 22 causes the PC 1 to execute the process of generating the control command to be transmitted to each of the printers, and transmitting the generated control command to all the printers selected in the process of Q32. The instructions in the process of Q33 is an example of a "transmission instructions of a control command", and the process of Q33 is an example of an "instruction acceptance process". Note that the user may perform the input operation indicating the instructions to start the accepting mode indicated in the process of Q21 before the starting instructions of the application program 22 in the process of Q11, or at a timing which is, for example, before the model specification in the process of Q31, after the process of Q31 and before the transmission instructions in the process of Q33, etc.

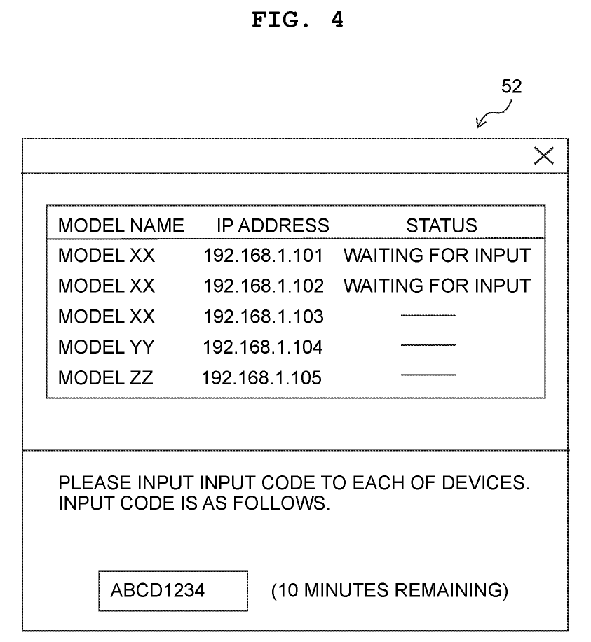

Further, the application program 22 causes the user I/F 13 of the PC 1 to display the information indicating the input code generated in the process of Q35 and transmitted in the process of Q36 (Q37). The process of Q37 is an example of a "displaying process". In a case where the input code is text information, the application program 22 causes the user I/F 13 to display information indicating the text, as depicted, for example, in FIG. 4. On the other hand, in a case where the input code is information indicating a predetermined operation, the application program 22 causes the user I/F 13 to display information indicating the predetermined operation. Since the application program 22 causes the user I/F 13 to display the information indicating the input code, occurrence of such a situation is reduced that the user forgets the input code and is unable to execute the process corresponding to the control command. Note that the application program 22 may perform the display in the process of Q37 prior to the transmission in the process of Q36.

Each of the printers is capable of receiving, via the network 200, the control command and is also capable of receiving the information on the input code included in the control command. A printer which has received the control command performs a process with respect to the received command, in accordance with the mode of itself. Specifically, the printers 31 and 32, which are in the accepting mode, store command information 313c and command information 323c based on the received control command in the memory 313 and the memory 323, respectively, for example as depicted in FIG. 1 (Q41), and change to a standby state which is a state of waiting for the input code (Q42). Further, the printer 31 transmits a response signal, indicating that the printer 31 has stored the command information and has changed to the standby state, to the application program 22 of the PC 1, and the printer 32 transmits a response signal, indicating that the printer 32 has stored the command information and has changed to the standby state, to the application program 22 of the PC 1 (Q43).

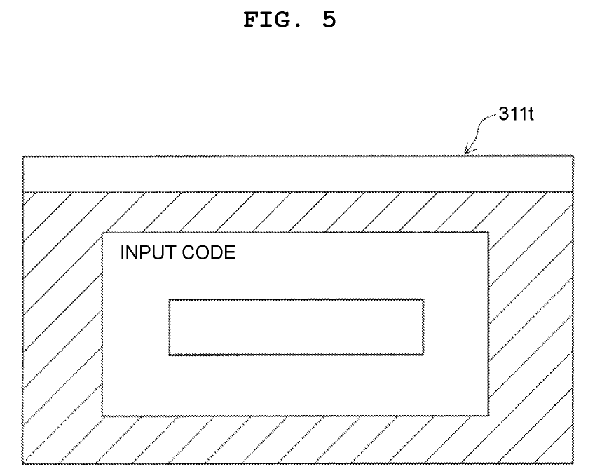

The standby state is a state that a printer waits for the input operation of the input code. The input operation of the input code is an example of a "second operation". In a case where the printer is in the accepting mode and has changed to the standby state, the printer enters such a state that the printer waits for the input operation of the input code, and that even in a case where the printer accepts another operation other than the input operation of the input code, the printer does not perform an operation corresponding to the another operation. For example, the printer 31 including the touch panel 311t causes the touch panel 311t to display an input field for accepting the input code, but does not cause the touch panel 311t to display, for example, any other icon, as depicted in FIG. 5. For example, in a case where a printer not including a liquid crystal panel accepts another operation other than the input operation of the input code, this printer emits, for example, a beep sound and ignores the another operation. In a case where a printer has changed to the standby state, the printer restricts the acceptance of another operation other than the input operation of the input code, thereby avoiding the occurrence of such a situation that the start of execution of the process corresponding to the control command is held due to the execution of a process corresponding to the another operation.

Note that, regarding each of the printers, a printer stores, in its memory in advance, a waiting period during which the standby state can be continued; in a case where a time elapsed since the beginning of the standby state exceeds the waiting period, the printer cancels the standby state by deleting the command information stored in its memory, and then the printer cancels the accepting mode and returns to the initial mode. The waiting period is an example of a "second period".The waiting period may be the same for the printers of various kinds, or may be different for each model. Each of the printers may accept a setting of the waiting period through a user operation. Further, the information on the waiting period may be included in the control command, rather than being stored in the printers, and each of the printers may obtain the information on the waiting period from the received control command.

In a case where the application program 22 accepts the response signal transmitted by a printer in the process of Q43, the application program 22 notifies, that the printer which has transmitted the response signal has changed to an input-waiting state, via the user I/F 13 of the PC 1 (Q45). The process of Q45 is an example of an "operation-waiting notification process". For example, in a case where the application program 22 receives the response signal from each of the printers 31 and 32, the application program 22 causes the user I/F 13 to display a status notification screen 52 which indicates that each of the printers 31 and 32 is in the input-waiting state, in association with their own IP addresses, as depicted in FIG. 4.

Further, the application program 22 may cause the user I/F 13 to display time information indicating a validity period of the transmitted input code, for example, as depicted in FIG. 4. The application program 22 may start measuring of a remaining time in a case where the application program 22 has completed the transmission of the control command in the process of Q36, or in a case where the application program 22 receives the response signal transmitted by the printer in the process of Q43. In a case where the remaining time of the standby state of each of the printers can be obtained for each of the printers, the application program 22 may cause the user I/F 13 to display information on the remaining time for each of the printers. Furthermore, the time information to be displayed is not limited to the information indicating the remaining time, but may be, for example, information indicating the time elapsed since the transmission of the control command. Moreover, the application program 22 may have the information on the waiting period for each of the printers in advance, or the information on the waiting period for one of the each of the printers may be transmitted from corresponding one of the each of the printers together with the response signal.

In other words, the application program 22 issues a notification of the presence of a printer which has changed to the standby state, and also displays the remaining time during which the input operation of the input code can be accepted, on the status notification screen 52. This expectedly encourages the user to perform the input operation of the input code.

In accordance with the notification in the process of Q45, the user inputs the input code displayed in the process of Q37 to each of the printers which is in the standby state (Q51). Specifically, the user inputs the input code to the printers 31 and 32, which are the printers as the control target, using their own user I/F.

Corresponding the input of the input code, each of the printers A31 and B32 reads out the command information stored in its memory and executes a process specified in the control command included in the command information (Q52). In a case where the control command includes the setting command including the information on the item or the parameter regarding which the main device setting of the printer is to be changed, each of the printers 31 and 32 applies the setting indicated in the setting command to the self. In a case where the control command includes the firmware updating command for causing a printer to update the firmware, each of the printers A31 and B32 updates the firmware and restarts. The process in which the printer applies the setting indicated in the setting command to the self or the process in which the printer updates the firmware and restarts is an example of a "specified process".

Note that in a case where the input code which has been input does not match the input code information included in the command information, a printer may accept the input of the input code again, or may delete the command information without performing the process of Q52, and then may return to the initial mode. Further, in a case where a printer accepts, a predetermined number of times, the input of the input code which does not match the input code information included in the command information, the printer may delete the command information.

In a case where a printer has completed all the processes corresponding to the control command, the printer transmits, to the PC 1, a completion signal indicating the completion of the process (Q53). Further, the printer deletes the command information stored in its memory (Q54), cancels the accepting mode, and returns to the initial mode (Q55). Each of the printers automatically returns to the initial mode after executing all the processes corresponding to the control command, thereby saving the user the trouble of changing the mode. Note that the accepting mode may be canceled by the user operation or may be canceled in a case where the cancel command is received from the PC 1. Note that each of the printers automatically changes to the initial mode after restarting, and deletes the command information.

In a case where the PC 1 receives the completion signal from a printer via the communication I/F 14, the application program 22 associates the completion signal with the IP address of the printer which has transmitted the completion signal, and issues a notification indicating the completion of the process (Q56). The process of Q56 is an example of a "completion notification process". This enables the user utilizing the application program 22 on the PC 1 to recognize the presence of the printer which has completed executing of the process.

On the other hand, the printer 33, which is of the same model as the printers 31 and 32 but which is still in the initial mode and has not changed to the accepting mode, receives the control command transmitted in the process of Q36. However, the printer 33 reads and discards the control command, without storing the information included in the received control command in the memory (Q47). More specifically, the printer 33 temporarily stores the command information included in the control commands in its memory in order to determine the type of the command which has been received. After determining that the received command is the control command, the printer 33 releases an area, of its memory, in which the command information has been stored, and causes the area to be in a state that command information, another data, etc., to be received next, can be stored in the area. In the present disclosure, the phrase "read(s) and discard(s) a (the) command" means temporarily storing the command information in the memory in order to determine the type of command, and then deleting the command information from the memory. In this case, the printer 33 does not change to the standby state and also does not transmit the response signal. Since the application program 22 does not receive the response signal from the printer 33, the application program 22 does not display the information indicating the status of the printer 33, for example, as depicted in FIG. 4.

The printer 33, which has not accepted the operation by the user to cause the printer 33 to change to the accepting mode, does not store the command information in its memory even in a case where the printer 33 receives the control command, and thus the memory load is small in the printer 33. For example, even in such a case where the input operation of the input code is similar to the input operation indicating the instructions to start the accepting mode, and that a third party unintentionally performs the input operation of the input code to the printer 33 which is still in the initial mode, the printer 33 does not execute the process corresponding to the control command since the printer 33 does not store the command information. Therefore, the control command is prevented from being applied to the printer which is not the control target.

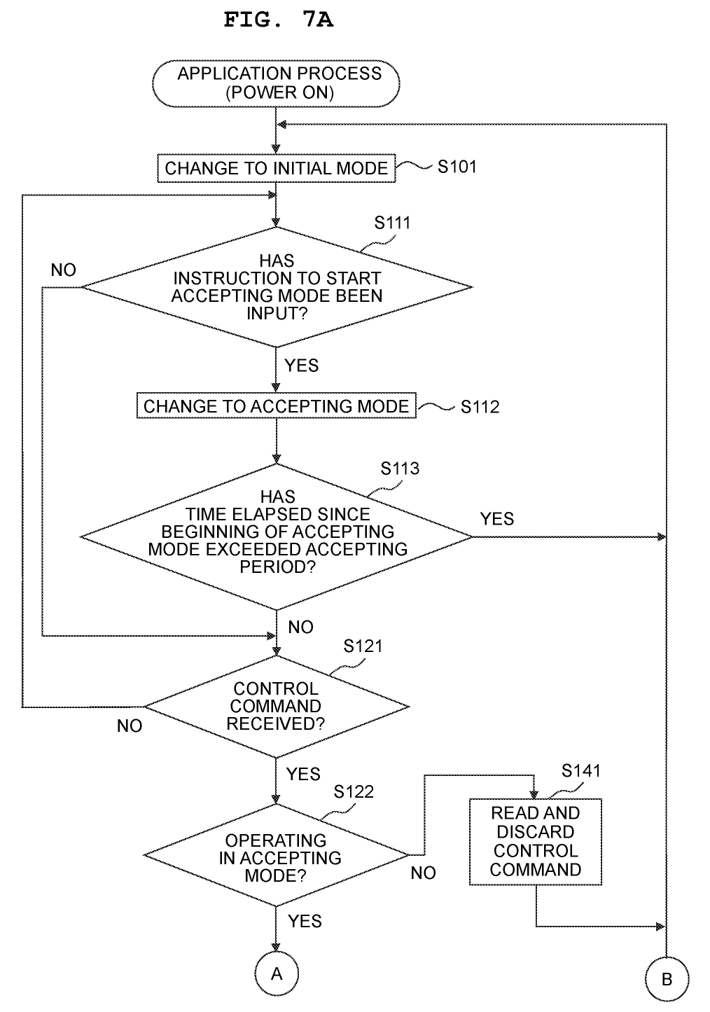

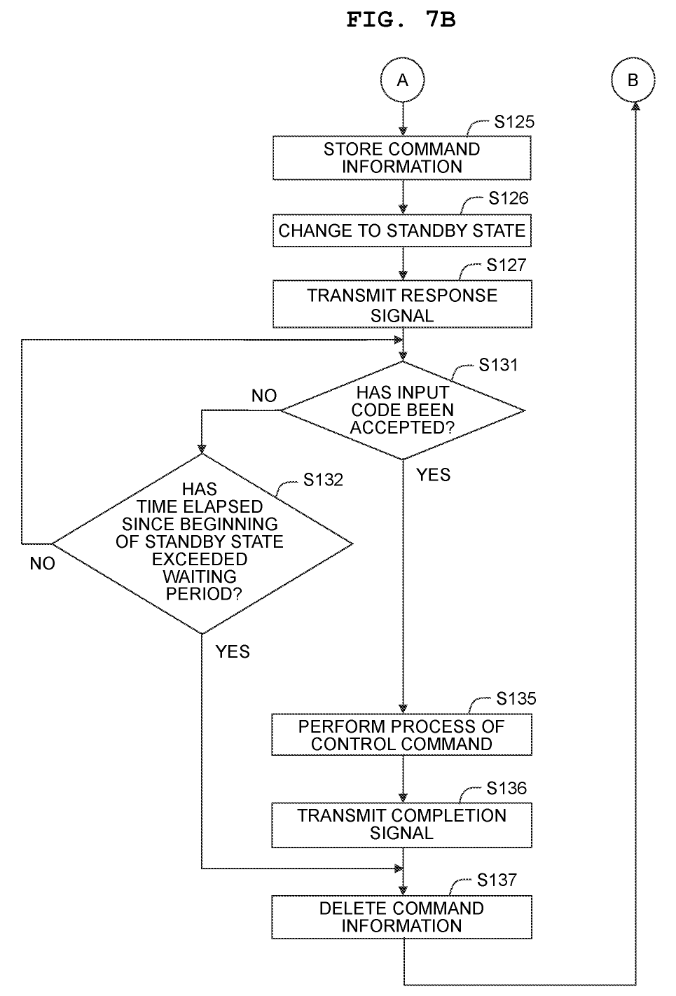

Next, a procedure of an application process executed in each of the printers will be described, with reference to the flowchart of FIGS. 7A and 7B and the sequence chart of FIGS. 2A and 2B. The application process is executed by the CPU of the printer in a case where a printer is started and connected to the network 200.

A printer connected to the network 200 first changes to the initial mode (step S101; Q01 in FIG. 2A). Then, the printer determines whether the instructions to start the accepting mode has been input via the user I/F (step S111). Although omitted in the flowchart of FIGS. 7A and 7B, the printer is capable of transmitting the response signal in a case where the printer receives the search signal transmitted from the PC. Further, the printer in the initial mode is capable of executing various kinds of image processing in accordance with the user operation.

In a case where the printer determines that the printer has accepted the input of the instructions to start the accepting mode (step S111: YES; Q21 in FIG. 2A), the printer changes to the accepting mode (step S112; Q22 in FIG. 2A) and starts measuring the time elapsed since the printer has changed to the accepting mode. Further, the printer determines whether the time elapsed since the printer has changed to the accepting mode exceeds a predetermined accepting period (step S113). In a case where the printer determines that the elapsed time has not exceeded the predetermined accepting period (step S113: NO), the printer determines whether the printer has received the control command (step S121). Each of the printers 31 and 32, which has accepted the input of the instructions to start the accepting mode in the process of Q22 in the procedure depicted in FIGS. 2A and 2B, changes to the accepting mode and waits for receiving of the control command.

In a case where the printer determines that the printer has received the control command(step S121: YES; Q36 in FIG. 2B), the printer determines whether the printer is in the accepting mode (step S122). In a case where the printer determines that the printer has received the control command while operating in the accepting mode (step S122: YES), the printer stores the command information in its memory, based on the received control command (step S125; Q41 in FIG. 2B), and changes to the standby state (step S126; Q42 in FIG. 2B). Further, the printer transmits the response signal to the PC which has transmitted the control command (step S127; Q43 in FIG. 2B). The printer 31 and the printer 32, each of which has received the control command in the procedure depicted in FIGS. 2A and 2B, stores the command information and changes to the standby state.

The printer which has changed to the standby state starts measuring of the time elapsed since the printer has changed to the standby state, and determines whether the printer has accepted the input operation of the input code (step S131). In a case where the printer determines that the printer has not accepted the input operation of the input code (step S131: NO), the printer determines whether the time elapsed since the printer has changed to the standby state has exceeded a predetermined waiting period (step S132). In a case where the printer determines that the elapsed time has not exceeded the predetermined waiting period (step S132: NO), the printer waits for receiving the input operation of the input code.

In a case where the printer determines that the printer has accepted the input operation of the input code (step S131: YES; Q51 in FIG. 2B), the printer reads out the command information stored in the step S125 and executes the process of the control command (step S135; Q52 in FIG. 2B). After completing the process of the control command, the printer transmits the completion signal to the PC which has transmitted the control command (step S136; Q53 in FIG. 2B). In a case where the printer 31 or 32 accepts the input operation of the input code in the procedure indicated in FIGS. 2A and 2B, then the printer 31 or the printer 32 executes the process of the control command.

In a case where the accepted input operation does not match the input code in the stored command information, the printer determines NO in the step S131. In other words, the printer executes the process of the control command on the condition that the input of the input code corresponding to the control command is accepted. Therefore, even in a case where a certain printer receives the control command transmitted by the user of another printer and the certain printer changes to the standby state, the certain printer is less likely to unnecessarily execute the process of the received control command.

After the step S136, or in a case where the printer determines that the time elapsed since the printer has changed to the standby state has exceeded the predetermined waiting period (step S132: YES), the printer deletes the command information stored in its memory (step S137; Q54 in FIG. 2B). Then, the printer proceeds to the step S101 and changes to the initial mode (Q55 in FIG. 2B). For example, in a case where the user performs the input operation of the input code with respect to the printer 31, but forgets to perform the input operation of the input code with respect to the printer 32, the printer 32 deletes the command information and changes to the initial mode.

Since the waiting period is set for the standby state, the standby state is less likely to be prolonged unnecessarily. Further, in a case where the waiting period has elapsed, the printer automatically returns to the initial mode, and thus the printer is capable of accepting the operation other than the input operation of the input code. This saves the user the trouble of returning the printer from the accepting mode to the initial mode.

In a case where the printer does not accept the input of the instructions to start the accepting mode (step S111: NO), the printer determines whether the printer has received the control command (step S121). In a case where the printer has not received the control command (step S121: NO), the printer waits for receiving of the input of the instructions to start the accepting mode and waits for receiving of the control command. For example, in the procedure depicted in FIGS. 2A and 2B, after the printer 34 and the printer 35 has responded to the device search, the printers 34 and 35 wait for receiving of the input of the instructions to start the accepting mode and waits for receiving of the control command.

In a case where the printer receives the control command in a state that the printer has not accepted the input of the instruction to start the accepting mode (step S121: YES), the printer determines that the printer is not in the accepting mode (step S122: NO), and reads and discards the received control command (S141; Q47 in FIG. 2B). In the procedure indicated in FIGS. 2A and 2B, the printer 33, which has not accepted the input of the instruction to start the accepting mode, receives the control command transmitted from the PC 1, but reads and discards the received control command since the printer 33 is still in the initial mode. After the step S141, the printer 33 proceeds to the step S101.

Further, in a case where the printer determines that the time elapsed since the printer has changed to the accepting mode has exceeded the predetermined accepting period (step S113: YES), the printer proceeds to the step S101, cancels the accepting mode, and changes to the initial mode. The predetermined accepting period is an example of a "first period". For example, a printer which is not the control target might change to the accepting mode due to an erroneous operation of the user or by becoming the control target by another user. Even if the printer has changed to the accepting mode, in a case where the elapsed time has exceeded the predetermined accepting period without receiving of the control command by the printer, the printer cancels the accepting mode and returns to the initial mode. Accordingly, the printer does not keep on waiting for receiving of the control command.

Next, a case where a plurality of PCs is connected within the communication range of the network 200, and where the application program 22 is executed in each of the plurality of PCs will be described. Specifically, for example, a PC 2 is connected to the same network 200 as the PC 1 as depicted in FIG. 1 in broken lines, and the application program 22 is also incorporated in the PC 2 in the same manner as the PC 1.

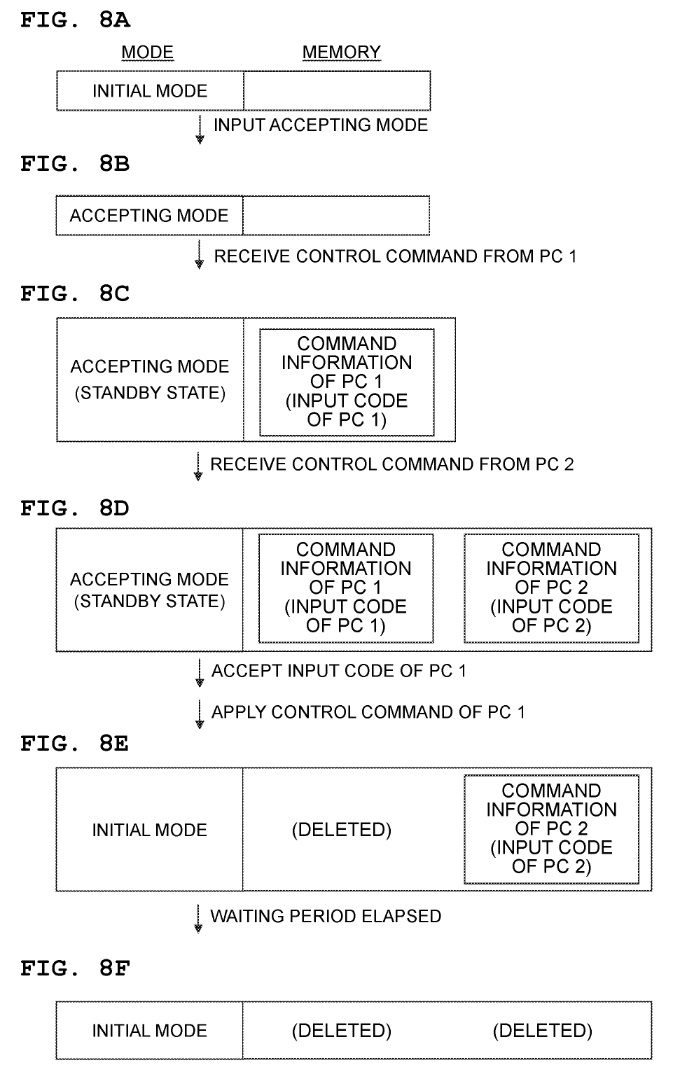

For example, in a case where the user of the PC 1 is executing the above-described application procedure with the printer 31 and the printer 32 as the control target, the user of the PC 1 causes the printer 31 and the printer 32 to change to the accepting mode. On the other hand, in a case where the user of the PC 2 intends to cause the printer 33 as the control target to execute a process corresponding to a control command which is different from the control command for the printers 31 and 32, the user of the PC 2 first causes the printer 33 to change to the accepting mode. As a result, the three printers which are the printer 31, the printer 32, and the printer 33 all change to the accepting mode, as depicted in FIG. 8B.

In this state, in a case where the user of the PC 1 instructs the PC 1 via the application program 22 to transmit the control command to the printer of the "model XX", the three printers, namely the printer 31, the printer 32, and the printer 33, each receive the control command transmitted from the PC 1. As a result, each of the printers 31, 32 and 33 stores the command information in its memory and changes to the standby state, as depicted in FIG. 8C. Then, in a case where the user of the PC 2 instructs PC 2 via the application program 22 to transmit the control command to the printer of the "model XX", each of the three printers 31, 32 and 33 receives the control command transmitted from the PC 2, and further stores the command information in its memory, as depicted in FIG. 8D.

The control command received from the PC 1 includes the information on the input code generated by the PC 1, and the control command received from the PC 2 includes the information on the input code generated by the PC 2. Then, each of the printers is capable of accepting the input operation of the input code generated by the PC 1 and the input operation of the input code generated by the PC 2.

In this case, the control command received from the PC 1 is an example of a "preceding control command", the command information based on the control command received from the PC 1 is an example of a "preceding command information", and the input operation of the input code generated by the PC 1 is an example of a "preceding second operation". The control command received from the PC 2 is an example of a "subsequent control command", and the command information based on the control command received from the PC 2 is an example of a "subsequent command information", and the input operation of the input code generated by the PC 2 is an example of a "subsequent second operation".

In this state, each of the printer 31 and the printer 32 accepts the input of the input code by the user of the PC 1, executes the process based on the command information of the PC 1, and as depicted in FIG. 8E, deletes the command information of the control command received from the PC 1 from its memory and returns to the initial mode. After returning to the initial mode, each of the printer 31 and the printer 32 does not accept the input of the input code. In other words, both the control commands transmitted from the PC 1 and the PC 2 are less likely to be applied in one printer. Further, based on elapse of the waiting period, the command information of the control command received from the PC 2 will be deleted from the memory, as depicted in FIG. 8F.

On the other hand, the user of the PC 2 inputs the input code generated by the PC 2 to the printer 33 which is in the state depicted in FIG. 8D. As a result, the printer 33 executes the process based on the command information from the PC 2, deletes the command information of the control command received from the PC 2 from its memory, and returns to the initial mode. Further, based on elapse of the waiting period, the command information of the control command received from the PC 1 will be deleted from the memory of the printer 33.

Even in a case where the plurality of users applies the control commands to the different printers connected to the same network 200 respectively, each of the plurality of users simply inputs the input code generated by the application program 22 used by himself or herself into the printer as the control target. Since each of the plurality of users does not input the input code to the printer which is not the control target, each of the printers is less likely to execute the erroneous process.

In a case where the input codes generated by the PCs are different from each other, the possibility of executing of the erroneous process by each of the printers is even lower. In order to make the input codes generated by the PCs different from each other, for example, the application program 22 may generate an input code including, for example, information indicating the PC in which the application program 22 is incorporated or information indicating the date and time of transmission of the control command. The command information regarding which the input of the input code is not accepted may be deleted from the memory by restarting the printer, rather than being deleted from the memory by the passage of time.

As described in detail in the foregoing, in a case where the control command is to be transmitted from the application program 22 of the PC 1, a printer as the control target changes from the initial mode to the acceptance mode based on the instruction to start the acceptance mode with respect to the printer by the user of the PC 1. Regarding each of the printers, in a case where a printer receives the control command while operating in the accepting mode, the printer stores the command information in its memory, and changes to the standby state; in a case where the input code is input to the printer in the standby state, the printer executes the process corresponding to the control command. On the other hand, in a case where the printer receives the control command while operating in the initial mode, the printer reads and discards the control command, and does not change to the standby state. In other words, even in a case where the plurality of users respectively instructs control target printers different from each other to start the accepting mode, each of the printers does not execute the process corresponding to the control command unless the input code is input. Therefore, even in a case where the plurality of users manages the different printers connected to the same network 200 from the plurality of PCs, respectively, a printer which is not the control target is less likely to execute the process corresponding to the control command.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, an example of the information processing apparatus may be, for example, a tablet computer or a smartphone, instead of the PC1. Further, the information processing apparatus may be three or more information processing apparatuses.

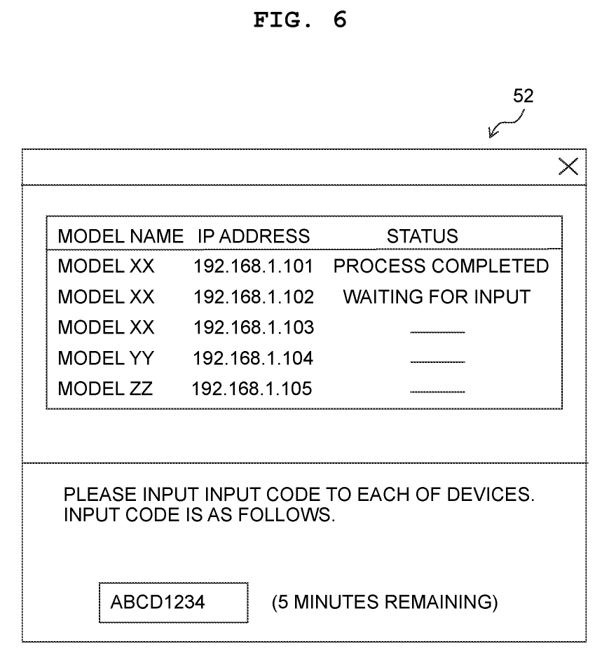

Each of the display screens depicted in the embodiment is an example, and is not limited to the depicted examples. For example, the application program 22 may not display the status notification screen 52 depicted in FIG. 4 or FIG. 6. Further, for example, each of the printers may not display the standby screen depicted in FIG. 5.

In the embodiment, although the application program 22 is configured to generate the input code, the application program 22 may be configured to accept the specification by the user.

For example, the accepting period or the waiting period may be omitted. For example, each of the printers may be configured to cancel the accepting mode and return to the initial mode depending on acceptance of a predetermined operation. For example, each of the printers may be configured to delete the command information stored in its memory depending on acceptance of a predetermined operation. Further, regarding each of the printers, a printer may be configured to overwrite the command information, in a case where the printer receives the control command in a state that the command information is stored in its memory.

In any one of the flowcharts disclosed in the embodiment, the order of executing a plurality of processes in any number of steps may be changed in any way, or a plurality of processes in any number of steps may be executed in parallel, as long as no contradiction arises in the contents of the processes.

The processes disclosed in the embodiment may be executed by a single CPU, a plurality of CPUs, hardware such as an ASIC, or a combination of those described above. Further, the process(es) disclosed in the embodiment may also be realized in various kinds of aspects, such as a storage medium storing a program to execute the process(s), or a method of executing the process(es), etc.

### Addendum

A person skilled in the art would appreciate that some aspects of the above-described embodiments and modifications are specific examples of the following aspect.

A system comprising:

an information processing apparatus; and

a plurality of image processing apparatuses, the information processing apparatus and the plurality of image processing apparatus being connected with each other via a network, wherein:

an image processing apparatus being each of the plurality of image processing apparatuses is operable in at least two modes including:

a first mode in which, in a case where the image processing apparatus receives a control command transmitted by a program of the information processing apparatus via the communication interface of the image processing apparatus, the image processing apparatus reads and discards the received control command; and

a second mode in which, in a case where the image processing apparatus receives the control command via the communication interface of the image processing apparatus, the image processing apparatus stores, in a memory, command information based on the received control command;

depending on acceptance of a first operation via the user interface of the image processing apparatus by the image processing apparatus operating in the first mode, the image processing apparatus is configured to change from the first mode to the second mode;

the information processing apparatus is:

capable of accepting transmission instructions of a control command to the image processing apparatus via a user interface of the information processing apparatus; and

configured to transmit the control command to at least one of the plurality of image processing apparatus by using the communication interface of the information processing apparatus depending on acceptance of the transmission instructions; and

the image processing apparatus is:

configured to change to a state of waiting for a second operation satisfying an execution condition of a specified process corresponding to the received control command, in a case where the image processing apparatus receives the control command via the communication interface of the image processing apparatus while operating in the second mode;

configured not to change to the state of waiting for the second operation, in a case where the image processing apparatus receives the control command via the communication interface of the image processing apparatus while operating in the first mode; and

configured to execute the specified process corresponding to the control command based on the command information stored in the memory depending on acceptance of the second operation via the user interface of the image processing apparatus in the state of waiting for the second operation.

WHAT IS CLAIMED IS:

1. An image processing apparatus comprising:
a user interface; and
a communication interface, wherein:
the image processing apparatus is operable in at least two modes including:
a first mode in which, in a case where the image processing apparatus receives a control command transmitted by a program of an information processing apparatus via the communication interface, the image processing apparatus reads and discards the received control command; and
a second mode in which, in a case where the image processing apparatus receives the control command via the communication interface, the image processing apparatus stores, in a memory, command information based on the received control command;
depending on acceptance of a first operation via the user interface by the image processing apparatus operating in the first mode, the image processing apparatus is configured to change from the first mode to the second mode;
in a case where the image processing apparatus receives the control command via the communication interface while operating in the second mode, the image processing apparatus is configured to change to a state of waiting for a second operation satisfying an execution condition of a specified process corresponding to the received control command;
in a case where the image processing apparatus receives the control command via the communication interface while operating in the first mode, the image processing apparatus is configured not to change to the state of waiting for the second operation; and
the image processing apparatus is configured to execute the specified process corresponding to the control command, based on the command information stored in the memory, depending on acceptance of the second operation via the user interface in the state of waiting for the second operation.

2. The image processing apparatus according to claim 1, wherein:
in a case where the image processing apparatus receives the control command via the communication interface, the image processing apparatus is capable of receiving a passcode associated with the control command;
in a case where the image processing apparatus receives the control command and the passcode while operating in the second mode, the image processing apparatus is configured to store, in the memory, the received passcode in association with the command information based on the received control command;
in the case where the image processing apparatus receives the control command via the communication interface while operating in the second mode, the image processing apparatus is configured to change to a state of waiting for a passcode as the state of waiting for the second operation; and
the image processing apparatus is configured to execute the specified process corresponding to the control command, based on the command information stored in the memory, depending on acceptance of an input of a passcode same as the received passcode, as the second operation, via the user interface in the state of waiting for the second operation.

3. The image processing apparatus according to claim 1, configured to change from the second mode to the first mode in a case where a first period elapses without receipt of the control command after the image processing apparatus has changed to the second mode.

4. The image processing apparatus according to claim 1, configured to delete the command information stored in the memory and to change from the second mode to the first mode in a case where a second period elapses without acceptance of the second operation since the image processing apparatus has changed to the state of waiting for the second operation.

5. The image processing apparatus according to claim 1, wherein in a case where the image processing apparatus completes execution of the specified process corresponding to the control command, the image processing apparatus is configured to delete the command information stored in the memory and to change from the second mode to the first mode.

6. The image processing apparatus according to claim 1, configured to restrict acceptance of an operation other than the second operation via the user interface in the state of waiting for the second operation.

7.The image processing apparatus according to claim 1, wherein:
in a case where the image processing apparatus receives a preceding control command as the control command via the communication interface while operating in the second mode, the image processing apparatus is configured to store, in the memory, preceding command information being the command information based on the preceding control command, and to change to a state of waiting for a preceding second operation being the second operation satisfying an execution condition of the specified process corresponding to the preceding control command;
in a case where the image processing apparatus receives a subsequent control command as the control command via the communication interface in the state of waiting for the preceding second operation, the image processing apparatus is configured to store, in the memory, subsequent command information being the command information based on the subsequent control command, and to change to a state of waiting for both the preceding second operation, and a subsequent second operation being the second operation satisfying an execution condition of the specified process corresponding to the subsequent control command;
depending on acceptance of the preceding second operation via the user interface in the state of waiting for both the preceding second operation and the subsequent second operation, the image processing apparatus is configured to execute the specified process corresponding to the preceding control command based on the preceding command information stored in the memory; and
depending on acceptance of the subsequent second operation via the user interface in the state of waiting for both the preceding second operation and the subsequent second operation, the image processing apparatus is configured to execute the specified process corresponding to the subsequent control command based on the subsequent command information stored in the memory.

8. The image processing apparatus according to claim 1, wherein the user interface includes a hardware key.

9. The image processing apparatus according to claim 1, wherein the user interface includes a keyboard.

10. The image processing apparatus according to claim 1, wherein the user interface includes a liquid crystal display with a touch panel.

11. An image processing apparatus comprising:
a user interface; and
a communication interface, wherein:
the image processing apparatus is configured to wait for reception of a control command transmitted by a program of an information processing apparatus, depending on acceptance of a first operation via the user interface;
depending on the reception of the control command via the communication interface by the image processing apparatus waiting for the reception of the control command, the image processing apparatus is configured to store, in a memory, command information based on the received control command, and to change to a state of waiting for a second operation satisfying an execution condition of a specified process corresponding to the received control command; and
depending on acceptance of the second operation via the user interface by the image processing apparatus in the state of waiting for the second operation, the image processing apparatus is configured to execute the specified process corresponding to the control command based on the command information stored in the memory.

12. A control method for an information processing apparatus, the control method comprising:
causing the information processing apparatus to execute an instruction acceptance process of accepting transmission instructions of a control command via a user interface of the information processing apparatus; and
causing the information processing apparatus to execute, depending on acceptance of the transmission instructions:
a determination process of determining an execution condition of a specified process corresponding to the control command; and
a transmission process of transmitting, to a plurality of image processing apparatuses via a communication interface of the information processing apparatus, the control command in association with condition information indicating the execution condition determined in the determination process,
wherein each of the plurality of image processing apparatuses to which the control command is to be transmitted in the transmission process is an image processing apparatus which is:
operable in at least two modes including:
a first mode in which, in a case where the image processing apparatus receives the control command, the image processing apparatus reads and discards the received control command; and
a second mode in which, in a case where the image processing apparatus receives the control command, the image processing apparatusstores, in a memory, command information based on the received control command;
configured to change from the first mode to the second mode depending on acceptance of a first operation;
configured to change to a state of waiting for a second operation satisfying the execution condition, in a case where the image processing apparatus receives the control command while operating in the second mode;
configured not to change to the state of waiting for the second operation, in a case where the image processing apparatus receives the control command while operating in the first mode; and
configured to execute the specified process corresponding to the control command based on the command information stored in the memory depending on acceptance of the second operation in the state of waiting for the second operation.

13. The control method according to claim 12, comprising causing the information processing apparatus to execute a displaying process of causing the user interface of the information processing apparatus to display text information indicating the execution condition determined in the determination process.

14. The control method according to claim 12, further comprising in a case where the information processing apparatus receives a response signal from an image processing apparatus, of the plurality of image processing apparatuses, which has changed to the state of waiting for the second operation, via the communication interface of the information processing apparatus, causing the information processing apparatus to execute an operation-waiting notification process of notifying presence of the image processing apparatus which has changed to the state of waiting for the second operation, in association with identification information on the image processing apparatus which has transmitted the response signal.

15. The control method according to claim 14, wherein:
in the transmission process, the control command is transmitted to an image processing apparatus, of the plurality of image processing apparatuses, which is configured to change from the second mode to the first mode in a case where a predetermined period elapses, since the image processing apparatus has changed to the state of waiting for the second operation, without acceptance of the second operation by the image processing apparatus; and
in the operation-waiting notification process, the presence of the image processing apparatus which has changed to the state of waiting for the second operation is notified, in association with the identification information on the image processing apparatus which has transmitted the response signal and time information based on the predetermined period based on which the image processing apparatus changes from the second mode to the first mode.

16. The control method according to claim 14, further comprising in a case where the information processing apparatus receives, via the communication interface, a completion signal from an image processing apparatus, of the plurality of image processing apparatuses, which has completed execution of the specified process corresponding to the control command, causing the information processing apparatus to execute a completion notification process of notifying presence of the image processing apparatus which has completed the execution of the specified process corresponding to the control command, in association with identification information on the image processing apparatus which has transmitted the completion signal.
